(19) United States
(12) Patent Application Publication
(10) Pub. No.: US 2009/0037836 A1
(43) Pub. Date: Feb. 5, 2009

(54) Interaction matrix creation tool

(75) Inventors: Anthony Duilio Moretti, Peoria, IL (US); Cole Douglas Hagen, Peoria, IL (US); Howard James Hilgers, Lafayette, IN (US); David A. Guldan, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/882,240

(22) Filed: Jul. 31, 2007

(51) Int. Cl. G06F 3/048

(52) U.S. Cl. 715/771

(57) ABSTRACT

A computer system for a system interaction matrix creation tool is provided. The computer system has a platform, at least one input device, and a central processing unit in communication with the platform and the at least one input device. The central processing unit is configured to display a system interaction matrix having a first dimension indexed to a plurality of affecting subsystems, and a second dimension indexed to a plurality of affected subsystems, receive a selection of one of the plurality affecting subsystems and a selection of one of the plurality of affected subsystems, and receive a selection of one of a plurality of types of interactions existing between the selected one of the plurality of affecting subsystems and the selected one of the plurality of affected subsystems. The central processing unit is further configured to receive a description of the selected interaction.

### TECHNICAL FIELD

The present disclosure is directed to interaction matrices, and, more particularly, to an interaction matrix creation tool.

### BACKGROUND

Companies in industries, such as, for example, the automotive industry and the consumer electronics industry, often provide complex products to their customers. These products (e.g., vehicles, electronic appliances, etc.) usually have many subsystems that each perform an individual task during operation of the system. For example, a passenger vehicle may have a transmission system, an exhaust system, a suspension system, a steering system, and other logical groupings of one or more machine components that cooperatively function during system operation to perform the individual task. Each of these subsystems may, in some way, interact with or affect the operation of other subsystems, and it may be useful to keep track of these interactions. For example, in the design of a system, each subsystem might be developed by a different engineering team, and, as such, the engineering teams should be able to identify when a change to its respective subsystem might interfere with or affect the operation of a subsystem assigned to a different team. Likewise, an engineering team should be able to identify when design changes to other subsystems might have some bearing on the operation of its own subsystem. Keeping track of these interactions may help identify and troubleshoot problems that arise in connection with the design, the manufacturing, and/or the performance of the subsystems.

A variety of tools have been developed to keep track of the interactions between the various subsystems of an overall system. One such tool is known as an interaction matrix, or an interface matrix. An interaction matrix includes a plurality of rows, each row being indexed to a different subsystem; and a plurality of columns, each column being indexed to a different subsystem. If an interaction exists between two different subsystems, a cell of the matrix corresponding to an intersection of the two different subsystems is visually distinguished to indicate the interaction.

One interface matrix tool is described in U.S. Patent Application Publication No. 2005/0138477 by Liddy et al., published on Jun. 23, 2005 (the '477 publication). The '477 publication describes an interface matrix diagram including a vertical axis listing each component of a system, and a horizontal axis listing each component of the system. The interface matrix diagram includes a box at each intersection of the vertical axis and the horizontal axis. Each box includes four quadrants indicating physical contact, energy transfer, information exchange, and a material exchange between the respective components associated with the box. Each quadrant includes a number ranging from −2 to +2 indicating the strength of the particular interaction. “−2” indicates a detrimental interaction, “−1” indicates an undesired interaction, “0” indicates indifference, “1” indicates a desired interaction, and “2” indicates a required interaction. The interface matrix diagram is used along with other tools to complete a failure modes and effects analysis (FMEA) form.

Although the interface matrix diagram of the '477 publication may provide a strength of an interaction between two components, its utility may be limited. Specifically, the amount of information that can be gleaned from the interface matrix may be relatively minimal, as only a strength of an interaction can be included therein. As such, it may not be particularly useful in the understanding, the design of, and/or troubleshooting the system.

The present disclosure is directed to overcoming one or more of the problems set forth above.

### SUMMARY OF THE INVENTION

One aspect of the present disclosure is directed to a tangibly-embodied computer readable medium. The computer readable medium may include instructions for displaying a system interaction matrix having a first dimension indexed to a plurality of affecting subsystems, and a second dimension indexed to a plurality of affected subsystems. The computer-readable medium may also include instructions for receiving a selection of one of the plurality affecting subsystems and a selection of one of the plurality of affected subsystems, receiving a selection of one of a plurality of types of interactions existing between the selected one of the plurality of affecting subsystems and the selected one of the plurality of affected subsystems, and receiving a description of the selected interaction.

Another aspect of the invention is directed to a method of visually displaying an interaction between related subsystems. The method may include displaying a system interaction matrix having a first dimension indexed to a plurality of affecting subsystems, and a second dimension indexed to a plurality of affected subsystems. The method may further include receiving a selection of one of the plurality affecting subsystems and a selection of one of the plurality of affected subsystems, receiving a selection of one of a plurality of types of interactions existing between the selected one of the plurality of affecting subsystems and the selected one of the plurality of affected subsystems, and receiving a description of the selected interaction.

### BRIEF DESCRIPTION OF THE DRAWINGS

FIG. 1 shows a block illustration of an exemplary disclosed interaction matrix creation environment;

FIG. 2 shows an exemplary graphical user interface (GUI) for use with the environment of FIG. 1; and

FIGS. 3 and 4 show exemplary windows for use with the GUI of FIG. 2.

### DETAILED DESCRIPTION

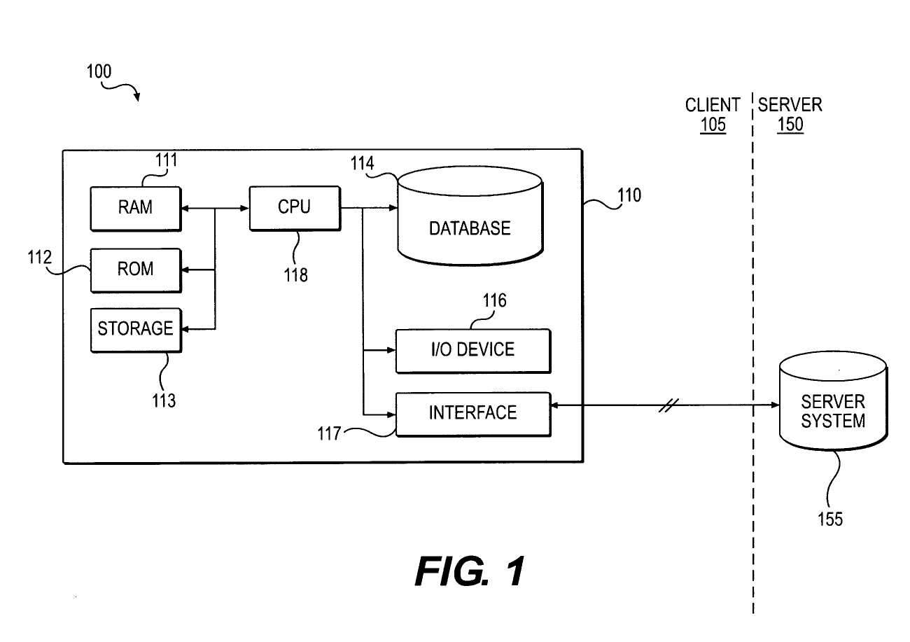

FIG. 1 provides a block diagram illustrating an exemplary disclosed interaction matrix creation environment 100. Interaction matrix creation environment 100 may include a client 105 and server 150. Client 105 may include one or more systems 110 that receive input from various sources, and provide output to a user in connection with the access, the display, the creation, the storage, the transfer of a system interaction matrix in connection with the present disclosure. Likewise, server 150 may include one or more server systems 155 that store and provide information to client 105 to facilitate these operations. Client 105 may represent, for example, an employee, a customer, an agent, a student, or another user of client system 110. Server 150 may represent, for example, an employer, a data service provider, or another entity that transmits, receives, and/or stores information relating to interaction matrices. Although illustrated as a single client 105 and a single server 150, a plurality of clients 105 may be connected to either a single, centralized server 150 or a plurality of distributed servers 150.

Client system 110 may be a platform including any type of processor-based system on which processes and methods consistent with the disclosed embodiments may be implemented. For example, client system 110 may be a desktop or laptop computer, a personal digital assistant (PDA), a cellular telephone, or another computing system known in the art. As illustrated in FIG. 1, client system 110 may include one or components configured to execute software programs. For example, client system 110 may include one or more hardware components, such as a random access memory (RAM) module 111, a read-only memory (ROM) module 112, a storage device 113, a database 114, one or more input/output (I/O) devices 116, and an interface 117, each in communication with a central processing unit (CPU) 118. Client system 110 may also include one or more software components, such as a computer-readable medium, including computer-executable instructions for performing methods consistent with the disclosed embodiments. One or more of the hardware components listed above may alternatively or additionally be implemented using software, if desired. For example, storage 113 may include a software partition associated with one or more other hardware components of client system 110. Client system 110 may include additional, fewer, and/or different components than those listed above, as the components listed above are exemplary only and not intended to be limiting.

RAM 111 and ROM 112 may each include one or more devices for storing information associated with operations of client system 110 and CPU 118. RAM 111 may include a memory device for storing data associated with one or more operations of CPU 118. For example, ROM 112 may load instructions into RAM 111 for execution by CPU 118. ROM 112 may include a memory device configured to access and store information associated with client system 110, including information for identifying, initializing, and monitoring the operation of one or more components of client system 110.

Storage 113 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Storage 113 may include, among other things, files and/or other data storage elements containing interaction matrix data for a variety of systems. In one embodiment, storage 113 may include a plurality of files each containing interaction matrix data for a particular system (e.g., a vehicle, an electronic appliance, an organization, etc.). In one aspect, the interaction matrix data may include first dimension data indexing a plurality of affecting subsystems (e.g., an air compressor system, a cooling system, a crankcase air system, etc.). The interaction matrix data may also include second dimension data indexing a plurality of affected subsystems (e.g., an air compressor system, a cooling system, a crankcase air system, etc.). The first dimension data and the second dimension data may include identical or different subsystems. In one aspect, the affecting subsystems may each potentially have an affect on, influence, or otherwise interact with one or more of the affected subsystems during operation of the overall system. For purposes of this disclosure, a subsystem may be considered a single component or a collection of interrelated components.

Interaction matrix data may also include interaction data about each interaction existing between the affecting subsystems and the affected subsystems. The interaction data may include, for example, a type, a strength, a magnitude, a sign (e.g., positive or negative), a desirability, a description, and/or other information about each interaction existing between each affecting subsystem and each affected subsystem. The types of interactions that may exist between a particular affecting subsystem and a particular affected system may fall into predetermined categories. The categories may include, for example, a material interaction, an information interaction, a physical interaction, and/or an energy interaction. A material interaction may indicate, for example, that a material (e.g., fuel, coolant, or air) flows from the affecting subsystem to the affected subsystem during system operation. An information interaction may indicate, for example, that an electrical signal containing information is transmitted from the affecting subsystem to the affected subsystem during operation. A physical interaction may indicate that the affecting system is in physical contact with the affecting subsystem during system operation. Similarly, an energy interaction may indicate, for example, that energy (e.g., heat energy, sound energy, light energy, etc.) flows from the affecting subsystem to the affected subsystem during system operation. In another aspect, the desirability of the interaction may be positive (+) or negative (−). A positive interaction may indicate that the interaction is beneficial to the system and/or is intended. Likewise, a negative interaction may indicate that the interaction occurs when it should not and/or is unintended. For example, a flow of fuel from a tank to the engine may be a positive material interaction, while a fuel leak (i.e., a flow of fuel from the tank to the atmosphere) may be a negative material interaction. Similarly, the engine being mounted to a frame may be a positive physical interaction, while engine wear caused by the mounting hardware contacting the engine may be a negative physical interaction. It is to be appreciated, however, that the interaction data stored in storage 113 may include additional, fewer, and/or different types of interaction data arranged according to different schemes, if desired. The examples described herein are included only for purposes of illustrating the present disclosure, and are not intended to be limiting. CPU 118 may access the data in storage 113 in connection with creating, retrieving, and/or storing a system interaction matrix, as described below.

Database 114 may include one or more software and/or hardware components that cooperate to store, organize, sort, filter, and/or arrange data used by client system 110, CPU 118, and/or server system 155. For example, database 114 may have stored therein a listing of available affecting systems, available affected systems, available types of interactions therebetween, available interaction strengths, and/or other information for a variety of systems. CPU 118 may access the information stored in database 115 in connection with creating, retrieving, and/or storing a system interaction matrix, as described below.

I/O devices 116 may include one or more components configured to communicate information to/from a user associated with client system 110. For example, I/O devices may include a console with an integrated keyboard and mouse to allow a user to input parameters associated with client system 110. I/O devices 116 may also include a display, such as a monitor, for outputting information. I/O devices 116 may also include peripheral devices such as, for example, a printer for printing information and reports associated with client system 110; a user-accessible disk drive (e.g., a USB port, a floppy, CD-ROM, or DVD-ROM drive, etc.) to allow a user to input data stored on a portable media device; a mouse; a microphone; a speaker system; or any other suitable type of information transducer. Data received and/or stored by client system 110 may be provided as output via I/O device 116 for printed display, viewing, and/or further communication to other system devices.

Interface 117 may include one or more components configured to transmit and receive data via a communication network, such as the Internet, a local area network, a workstation peer-to-peer network, a direct link network, a wireless network, or any other suitable communication platform. In this manner, client system 110 and server system 155 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

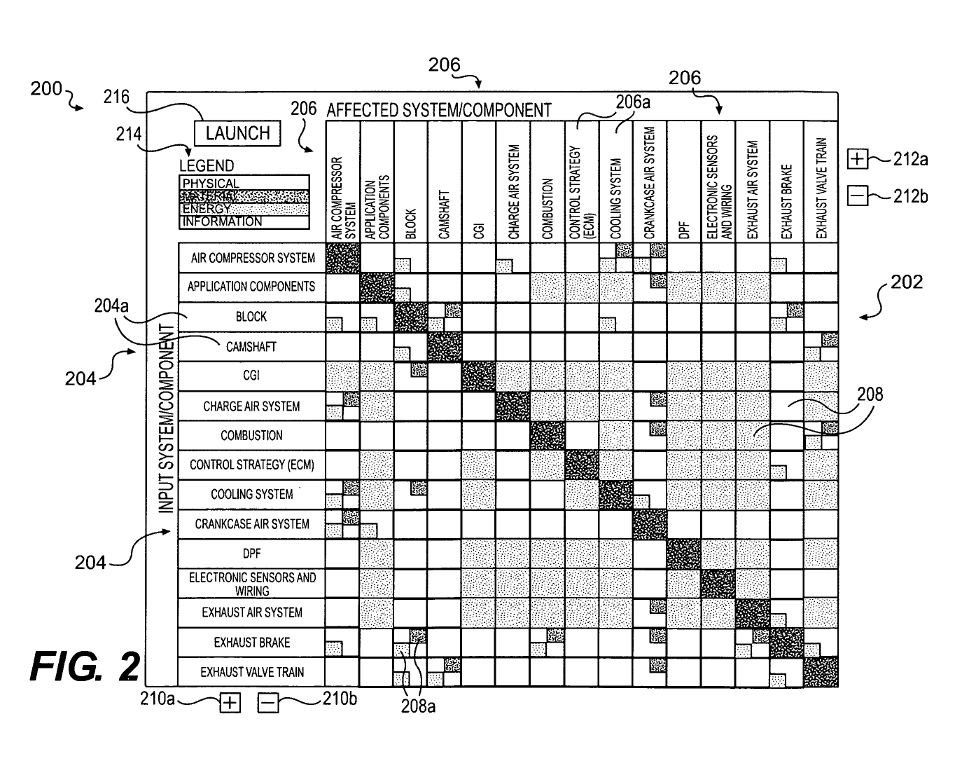

CPU 118 may include one or more processors configured to execute instructions and process data to perform one or more functions associated with client system 110. For example, CPU 118 may be configured to execute sequences of computer program instructions to perform various processes in connection with the execution of the disclosed system matrix interaction creation tool, which will be described in detail below with reference to FIGS. 2-4. The computer program instructions may be loaded into RAM 111 for execution by CPU 111.

Server system 155 may provide a web interface to a user at client 105 to create, retrieve, view, and/or store a system interaction matrix, as described below. Although not illustrated, server system 155 may include components similar to those described above with respect to client system 110.

FIGS. 2-4 show an exemplary graphical user interface (GUI) 200 to create, access, view, store, and/or retrieve a system interaction matrix. GUI 200 may be executed and provided to a user by way of client system 110 and/or server system 155. For example, GUI 200 may be displayed to a user via I/O device 116 and/or a similar I/O device associated with server system 155. Likewise, GUI 200 may receive input from the user via appropriate input to I/O device 116 and/or a similar I/O device associated with server system 155.

GUI 200 may be a software tool, such as an Internet or dedicated intranet web interface, allowing a user to create and manage system interaction matrices, as discussed below. In another example, GUI 200 may be a macro or another software application written in Visual Basic™ and designed to run in a spreadsheet program, such as, for example Microsoft Excel™. GUI 200 may include menus, modules, buttons, toolbars, and other means to facilitate the creation and management of interaction matrices and the transfer of information between client system 110 and server system 155.

Referring to FIG. 2, GUI 200 may include a system interaction matrix 202. Interaction matrix 202 may be a diagram generated based on information about a particular system loaded or otherwise accessed from storage 113, database 114, and/or server system 155. Interaction matrix 202 may include a first dimension 204 (e.g., rows) indexed to a plurality of affecting subsystems 204a of the particular system, and a second dimension 206 (e.g., columns) indexed to a plurality of affected subsystems 206a of the particular system. Interaction matrix 200 may also include a plurality of cells 208 corresponding to an intersection between each of the plurality of affecting subsystems 204a and each of the plurality of affected subsystems 206a. Interaction matrix 200 may further include interaction indicators 208a within each of cells 208. Each interaction indicator 208a may correspond to a specific type of interaction that exists between the particular affecting subsystem 204a and the particular affected subsystem 206a, such as, for example, the material, information, physical, and/or an energy interaction types mentioned above. In one aspect, different interaction types may be distinguished by interaction indicators 208a of different colors, shades, icons, etc.

GUI 200 may further include an affecting system add button 210a and an affecting system remove button 210b. Similarly, GUI 200 may include an affected system add button 212a and an affected system remove button 210b. Selection of add buttons 210a and 210b may allow a user to add a one or more desired affecting and affected subsystems to interaction matrix 202. In one example, selection of add buttons 210a and 212a may cause GUI to display a drop-down menu (not shown) allowing the user to select therefrom and add to interaction matrix 202 desired affecting subsystems 204a and affected subsystems 206a, respectively, from those available in database 114. Alternatively or additionally, GUI 200 may display a menu (not shown) allowing the user to type in a name for a desired affecting subsystem 204a and/or affected subsystem 206a. Still further, the user may selectively place a cursor at a desired location within first dimension 204 and/or second dimension 206, and then press an appropriate key (e.g., enter, tab, etc.) to make space in the first dimension 204 and/or second dimension 208 in order to type in or otherwise add a new affecting subsystem 204a and/or affected subsystem 206a thereto.

Similarly, selection of remove buttons 210b and 212b may cause GUI 200 to display a list or menu (not shown) of the affecting subsystems 204a and affected subsystems 206a, respectively, presently contained in interaction matrix 202. The user may then click on or otherwise select a desired affecting subsystem 204a and/or affected subsystem 206a to be removed from interaction matrix 202. Still further, the user may selectively place a cursor at a desired location within first dimension 204 and/or second dimension 206, and press an appropriate key (e.g., delete, backspace, etc.) to delete or otherwise remove a desired affecting subsystem 204a and/or affected subsystem 206a therefrom. Upon completion of the addition or removal of desired subsystems, GUI 200 may update interaction matrix 202 to reflect the changes. That is, GUI 200 may add or remove subsystems and cells 208 associated therewith.

GUI 200 may also include a legend 214 containing information about various features or symbols shown on interaction matrix 202. Legend 214 may be, for example, a color-coded or otherwise visually distinguished listing of the names of the types of interactions shown on interaction matrix 202 (e.g., material, information, physical, and/or energy). Alternatively or additionally, legend 214 may list the names and meanings of symbols displayed on interaction matrix 202. Legend 214 may contain different or additional information about interaction matrix 202, if desired.

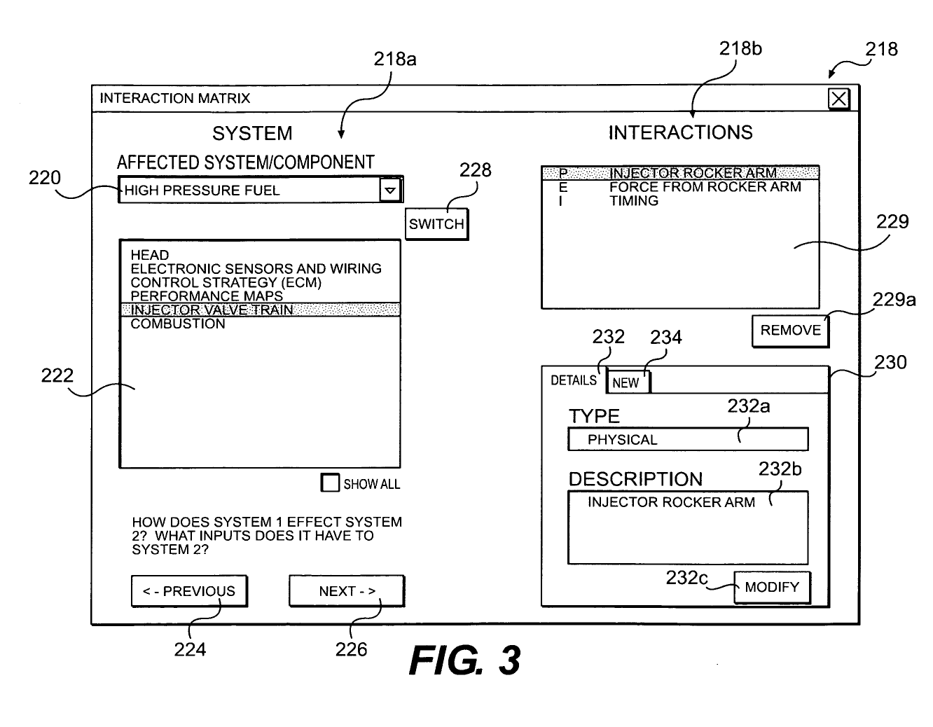

GUI 200 may further include a launch button 216. Selection of launch button 216 may cause GUI 200 to display a window 218 (FIG. 3), allowing the user to add to interaction matrix 202 additional interactions between affecting subsystems 204a and affected subsystems 206a, and/or to add descriptive details about interactions already existing therebetween. That is, window 218 may allow the user to further define the interactions in the system, and, thereby, improve the utility of interaction matrix 202.

Turning to FIG. 3, window 218 may include a subsystem portion 218a and an interactions portion 218b. Subsystem portion 218a may include a drop-down menu 220 containing all of the affecting subsystems contained in interface matrix 202 for the particular system. Subsystem portion 218a may also contain a selectable listing 222 of all of the affected subsystems contained in interface matrix 202 for the system. Subsystem portion 218a may also include a previous button 224 and a next button 226 to allow the user to navigate through the subsystems shown in listing 220. Subsystem portion 218a may further include a switch button 228 allowing the user to select whether the affecting subsystems or the affected subsystems are shown in drop-down menu 220 or are selectable from listing 220. In this manner, selection of switch button 228 may toggle between a first state in which previous button 224 and next button 226 allow navigation through the affecting subsystems, and a second state in which previous button 224 and next button 226 allow navigation through the affected subsystems.

Interactions portion 218b may include a selectable interaction listing 229 and an interaction details feature 230. In response to a user's selection of a particular affecting subsystem and a particular affected subsystem from menu 220 and listing 222, respectively, GUI 200 may display in interaction listing 229 all of the types of interactions existing between the selected affecting subsystem and the selected affected subsystem (e.g., material, information, physical, and/or energy). Interaction listing 229 may be associated with a remove button 229a. The user may select an interaction shown in interaction listing 229 and then select remove button 229a to delete or otherwise remove the selected interaction from interaction matrix 202.

Interaction details feature 230 may include an interaction details tab 232 having a type field 232a, a description field 232b, and a modify button 232c. In response to the user's selection of a particular interaction from interaction listing 228, GUI 200 may display the type of the selected interaction in field 232a (e.g., physical), and a previously-received description of the type of interaction in field 232b (e.g., “Injector rocker arm”), if any. Further, the user may place a cursor in description field 232b, and type or otherwise input a textual description for the selected interaction. In one aspect, the description may provide further information about the selected interaction. For example, the description may explain how the affecting subsystem interacts with the affected subsystem. In the example shown in FIG. 3, the injector valve train (affecting subsystem) may physically interact with the high pressure fuel system (affected subsystem) by way of an injector rocker arm. It is to be appreciated, however, that the user may enter any desired description that may be useful in understanding, designing, modifying, troubleshooting, and/or assembling the overall system. Upon selection of modify button 232c, GUI 200 may update listing 229 interaction matrix 202 to reflect any changes made.

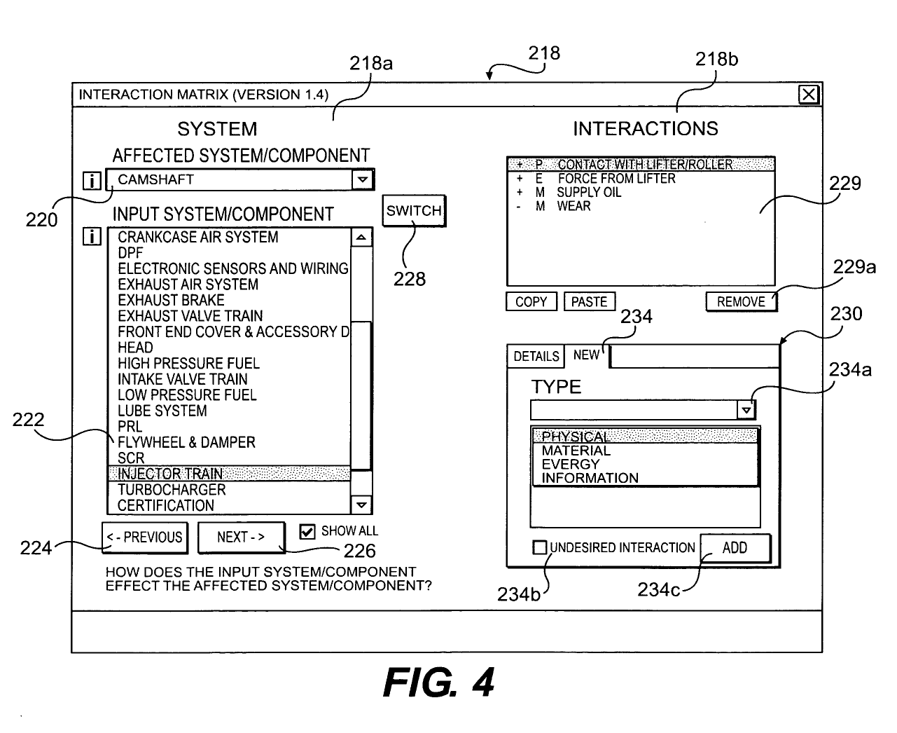

Turning to FIG. 4, interaction details feature 230 may also include a new interaction tab 234 allowing the user to add a new type of interaction between the selected affecting subsystem and the selected affected subsystem. New interaction tab 234 may include a type drop-down menu 234a allowing the user to select a desired type of interaction to add (e.g., material, information, physical, and/or energy). Tab 234 may also include an undesirable interaction selector 234b (e.g., a check-box) allowing the user to select whether the added interaction is desirable or undesirable (i.e., positive or negative). Upon selection of an add button 234c, GUI 200 may update interaction listing 229 and interaction matrix 202 to reflect the newly-added interaction.

It is to be appreciated that any changes or modifications made to interaction matrix 202 using the previously-described features of window 218 may be stored in storage 113 and/or server system 155 upon exiting GUI 200 and/or saving interaction matrix 202. That is, a file for interaction matrix 202 contained in storage 113 and/or server system 155 may be saved or otherwise updated to reflect changes made to interaction matrix 202.

In another embodiment, selection of a particular interaction indicator 208a may alternatively or additionally launch window 218. In one aspect, GUI 200 may launch window 218 with the affecting subsystem, the affected subsystem, the type of interaction, and the description of the interaction corresponding to the particular interaction indicator 208a already selected and displayed in drop-down menu 220, selectable listing 222, type field 232a, and description field 232c, respectively. Subsequently, operation of window 218 and control of GUI 200 may be the same as described above.

Those skilled in the art will appreciate that all or part of systems and methods consistent with the present disclosure may be stored on or read from other computer-readable media. Referring to FIG. 1, interaction matrix creation environment 100 may include a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory, such as read-only memory (ROM) 112 or random-access memory (RAM) 111. Such computer-readable media may be embodied by one or more components of interaction matrix creation environment 100, such as CPU 118, storage 113, database 114, server system 155, or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to accomplish the individual tasks described above for each module, script, and daemon. For example, these program modules may be implemented using commercially available software tools, using custom object-oriented code written in the C++™ programming language or the Visual Basic™ programming language; using applets written in the Java™ programming language; or may be implemented with discrete electrical components or as one or more hardwired application specific integrated circuits (ASIC) that are custom designed for this purpose.

The described implementation may include a particular network configuration but embodiments of the present disclosure may be implemented in a variety of data communication network environments using software, hardware, or a combination of hardware and software to provide the processing functions.

### INDUSTRIAL APPLICABILITY

The disclosed interaction matrix creation tool may facilitate the creation of a comprehensive interaction matrix. Specifically, GUI 200 may allow a user to create an interaction matrix including description of and/or details about the various interactions existing between the subsystems of the overall system. This descriptive information may aid in understanding, designing, modifying, troubleshooting, and/or assembling the overall system. Operation of GUI 200 will now be explained.

A user at client system 110 may access GUI 200 and load a file having stored thereon an interaction matrix for a particular system (e.g., a vehicle). The user may be, for example, one member of an engineering team responsible for designing an air compressor subsystem of the vehicle. While designing the vehicle, a change may be made to the air compressor such that compressed air must be supplied to a cooling subsystem. The design change may call for a supply hose to run from an outlet port on the air compressor to an inlet port on the cooling system. The design change may further call for an increase in size of the air compressor housing that causes a side of the air compressor to physically contact a side of the cooling subsystem. As such, the air compressor subsystem may be the affecting subsystem, while the cooling subsystem may be the affected subsystem. The types of interactions between the affecting subsystem (air compressor subsystem) and the affected subsystem (cooling subsystem) may be material (i.e., a flow of compressed air from the compressor subsystem to the cooling subsystem), and physical (i.e., the air compressor subsystem physically contacts the cooling subsystem).

Referring to FIG. 2, the user may select launch button 216 or select a cell 208 within interaction matrix 202 corresponding to the intersection between the compressor subsystem and the cooling subsystem. GUI 200 may then display window 218 to the user, as shown in FIGS. 3 and 4. The user may then select the cooling subsystem from drop-down menu 220 and the air compressor subsystem from selectable listing 222. In response to the selection, GUI 200 may display in interaction listing 229 any previously-stored interactions existing between the compressor subsystem and the cooling subsystem. Interaction listing 229 may contain, for example, no previously-stored interactions. As such, the user may wish to add the new interactions incurred as a result of the design changes discussed above. Referring to FIG. 4, the user may select new interactions tab 234. The user may then select “material” from type drop-down menu 234a, followed by add button 234c. Likewise, the user may select “physical” from type drop-down menu 234a, followed by add button 234c. In response, GUI 200 may update interaction listing 229 and interaction matrix 202 to reflect the newly-added interactions.

The user may wish to add descriptions and/or other details about each of the newly-added interactions. Turning to FIG. 3, the user may select interaction details tab 232. The user may then select “M” (i.e., material) from the interaction listing 229. GUI 200 may then update interaction type field 232a to display “Material” therein. The user may then position the cursor in description field 232b, and enter a description and/or other details about the material interaction. For example, the user might enter: “A quarter-inch diameter supply hose (Part No. 123456) to provide compressed air from the compressor to the cooling system must run from outlet port A of the air compressor to inlet port B of the cooling system. The supply hose should be 6.5 inches in length.” After completing the description, the user may select modify button 232c. In response, GUI 200 may update interaction listing 229 and interaction matrix 202 to reflect the description. That is, the description may be recorded and/or stored.

Likewise, the user may wish to enter a description and/or details about the newly-added physical interaction. As such, the user may select “P” (i.e., physical) from the interaction listing 229. GUI 200 may then update interaction type field 232a to display “Physical” therein. The user may then position the cursor in description field 232b, and enter a description and/or details about the physical interaction. For example, the user might enter: “A new design for the housing of the air compressor causes a side of the compressor to abut a side of the cooling subsystem. Consider placing insulation material between abutting sides to prevent wear.” The user may then select modify button 232c to record the description and update interaction listing 229 and interaction matrix 202. Further, referring to FIG. 3, since the newly-added physical interaction may cause wear of the air compressor subsystem and/or the cooling subsystem, which is a negative, or an undesirable interaction, the user may select new interaction tab 234 and check the box of undesirable interaction selector 234b to indicate that the physical interaction is negative and/or undesirable. The user may then update interaction listing 229 and interaction matrix 202 by selecting add button 234c.

Upon completion of updating and/or saving interaction matrix 202, subsequent users (e.g., members of other engineering teams) thereof may be able to access the descriptions entered for the material and physical interactions between the air compressor subsystem and the cooling subsystem. For example, an engineer/user on a team responsible for designing the cooling subsystem may access interaction matrix 202. The user may, upon a visual inspection of interaction matrix 202, notice that a new material interaction and a new physical interaction are indicated between the air compressor subsystem and the cooling subsystem. As such, the user may then launch window 218 and display the newly-added descriptions and/or details about the material interaction and the physical interaction in one of the ways discussed above. For example, the user may select launch button 216 and/or select the particular interaction indicator 208a in the intersection cell 208 of interest. Upon becoming familiar with the description and/or details of the interactions, the user may be able to take proper measures to ensure the smooth design of the air compressor subsystem, as well as the overall system. For example, the user may be compelled have the air compressor design team cooperate with the cooling subsystem design team to ensure that design goals may be met in an appropriate and efficient manner.

The interaction matrix creation tool of the present disclosure may allow the creation of a comprehensive interaction matrix. Specifically, because this tool allows a user to record descriptions and/or details about interactions between subsystems of an overall system, the interaction matrix may be rendered more useful in the understanding, designing, modifying, troubleshooting, and/or assembling of the system.

It will be apparent to those skilled in the art that various modifications and variations can be made to the disclosed interaction matrix creation tool. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium, tangibly embodied, having stored thereon instructions for:
displaying a system interaction matrix having a first dimension indexed to a plurality of affecting subsystems, and a second dimension indexed to a plurality of affected subsystems;
receiving a selection of one of the plurality affecting subsystems and a selection of one of the plurality of affected subsystems;
receiving a selection of one of a plurality of types of interactions existing between the selected one of the plurality of affecting subsystems and the selected one of the plurality of affected subsystems; and
receiving a description of the selected interaction.

2. The computer-readable medium of claim 1, further including instructions for displaying in a cell of the interaction matrix corresponding to an intersection between each of the plurality of affecting subsystems and each of the plurality of affected subsystems, a visual indication associated with each type of interaction existing therebetween.

3. The computer-readable medium of claim 2, further including instructions for:
receiving a selection a visual indication; and
displaying a previously-received description of the type of interaction associated with the selected visual indication.

4. The computer-readable medium of claim 1, further including instructions for:
adding an affecting subsystem to the plurality of affecting subsystems; and
adding an affected subsystem to the plurality of affected subsystems.

5. The computer-readable medium of claim 1, wherein the plurality of types of interactions include at least one of a physical interaction, an energy interaction, a material interaction, and an information interaction.

6. The computer-readable medium of claim 1, further including instructions for storing the system interaction matrix and the description.

7. The computer-readable medium of claim 1, wherein the selected one of the plurality of affecting subsystems affects the selected one of the plurality of affected subsystems by way of the selected interaction.

8. A method of visually displaying an interaction between related subsystems, comprising:
displaying a system interaction matrix having a first dimension indexed to a plurality of affecting subsystems, and a second dimension indexed to a plurality of affected subsystems;
receiving a selection of one of the plurality affecting subsystems and a selection of one of the plurality of affected subsystems;
receiving a selection of one of a plurality of types of interactions existing between the selected one of the plurality of affecting subsystems and the selected one of the plurality of affected subsystems; and
receiving a description of the selected interaction.

9. The method of claim 8, further including displaying in a cell of the interaction matrix corresponding to an intersection between each of the plurality of affecting subsystems and each of the plurality of affected subsystems, a visual indication associated with each type of interaction existing therebetween.

10. The method of claim 9, further including:
receiving a selection of a visual indication; and
displaying a previously-received description of the type of interaction associated with the selected visual indication.

11. The method of claim 8, further including:
adding an affecting subsystem to the plurality of affecting subsystems; and
adding an affected subsystem to the plurality of affected subsystems.

12. The method of claim 8, wherein the plurality of types of interactions include at least one of a physical interaction, an energy interaction, a material interaction, and an information interaction.

13. The method of claim 8, further including storing the system interaction matrix and the description.

14. The method of claim 8, wherein the selected one of the plurality of affecting subsystems affects the selected one of the plurality of affected subsystems by way of the selected interaction.

15. A computer system, comprising:
a platform;
at least one input device; and
at least one central processing unit in communication with the platform and the at least one input device, the central processing unit being configured to:
display a system interaction matrix having a first dimension indexed to a plurality of affecting subsystems, and a second dimension indexed to a plurality of affected subsystems;
receive a selection of one of the plurality affecting subsystems and a selection of one of the plurality of affected subsystems;
receive a selection of one of a plurality of types of interactions existing between the selected one of the plurality of affecting subsystems and the selected one of the plurality of affected subsystems; and
receive a description of the selected interaction.

16. The computer system of claim 15, wherein the central processing unit is further configured to display in a cell of the interaction matrix corresponding to an intersection between each of the plurality of affecting subsystems and each of the plurality of affected subsystems, a visual indication associated with each type of interaction existing therebetween.

17. The computer system of claim 16, wherein the central processing unit is further configured to:
receive a selection of a visual indication; and
display a previously-recorded description of the type of interaction associated with the selected visual indication.

18. The computer system of claim 15, wherein the central processing unit is further configured to:
add an affecting subsystem to the plurality of affecting subsystems; and
add an affected subsystem to the plurality of affected subsystems.

19. The computer system of claim 15, wherein the plurality of types of interactions include at least one of a physical interaction, an energy interaction, a material interaction, and an information interaction.

20. The computer system of claim 15, wherein the central processing unit is further configured to store the system interaction matrix and the description.
